(19) United States
(12) Patent Application Publication
(10) Pub. No.: US 2025/0178494 A1
(43) Pub. Date: Jun. 5, 2025

(54) LOAD LEG ENERGY ABSORPTION SYSTEM

(71) Applicant: Britax Child Safety, Inc., Fort Mill, SC (US)

(72) Inventors: Quentin Walsh, Fort Mill, SC (US); Janis Skujins, Delano, MN (US); Angela Stacey, St. John's Newfoundland (CA); Nick Rydberg, Stillwater, MN (US); Dan Ross, Vadnais Heights, MN (US); Patrick Jan Boldenow, Bloomington, MN (US)

(21) Appl. No.: 18/970,628

(22) Filed: Dec. 5, 2024

Related U.S. Application Data
(60) Provisional application No. 63/606,443, filed on Dec. 5, 2023.

(51) Int. Cl. B60N 2/28

(52) U.S. Cl. CPC B60N 2/2884; B60N 2/2824

(57) ABSTRACT

Disclosed herein is a system that absorbs energy in a collision and reduces crash forces. The system comprises a load leg positioned to abut against a floor of a vehicle; a support component configured to engage with corresponding coupling components of a child safety seat to secure the child safety seat to a selected vehicle seat and restrict displacement movements therebetween when a collision occurs; and an energy absorption assembly configured to connect the load leg and the support component and absorb crash energy during the collision by at least limiting or eliminating downward motions of a child occupant in the child safety seat.

### PRIORITY CLAIM AND CROSS-REFERENCE TO RELATED APPLICATIONS

This application claims priority to and the benefit of U.S. Provisional Patent App. No. 63/606,443 filed Dec. 5, 2023, titled LOAD LEG ENERGY ABSORPTION SYSTEM, the contents of which are incorporated by reference herein in their entirety and relied upon.

### FIELD OF TECHNOLOGY

The present disclosure generally relates to a system for car safety seats, and more particularly relates to a load leg energy absorption system used with a child safety seat that is configured to absorb crash energy during a car collision by deforming at least one sacrificial component inside of a load leg of the system.

### BACKGROUND

Car seats provide protection for infants and children in a crash, yet car crashes are a leading cause of death for young children. It is of great importance for caregivers to choose and use the right car seat and accessories correctly every time a child is in the car. For example, children under the age of one should always be in a rear-facing seat in the back seat. They should remain in a rear-facing seat until they reach the top height or weight limits listed on the seat. In a crash, a rear-facing car seat may help decrease the risk of injuries, because it protects the head, neck and spine by of a child occupant distributing the force of a crash over the entire body. Small children have fragile necks and spinal cords, and a rear-facing seat reduces the amount of stress on these critical areas. A child may move into a forward-facing seat with a harness that is installed in the back seat using a seat belt or lower anchors and a tether. During a crash, the harness distributes the forces of the crash across the child's body and keeps the child in the seat. The tether limits the child's forward head movement. However, current car safety measures may primarily rely upon various attachments such as harnesses, seat belts and latch belts, and the forces resulting from a crash collision may be transmitted to the child occupant and cause serious injury.

Accordingly, there is a need for an improved child safety seat accessory that absorbs energy in a collision and reduces crash forces.

### SUMMARY

The present disclosure provides a load leg energy absorption system to be used with a child safety seat, the system comprising a load leg having a sacrificial element that is deformed or destroyed by a translational or torsional load of a crash impact during a car collision, thereby reducing car crash energy passed to a child occupant. For example, the load leg energy absorption system may use a torsional design where the rotational motions of a load leg causes one or more pins to shear as disclosed below with respect to FIGS. 1-3, or a torsional design where the rotational motions of the load leg causes a pin to be pushed through a curved slit that starts equal to the diameter of the pin but decreases to be narrower than the pin, as disclosed below with respect to FIGS. 4-9. A number of alternate embodiments are illustrated in FIGS. 10-15, in accordance with aspects of the present disclosure. For example, additional torsional design of the load leg energy absorption system may relate to bending or deforming a rod or tube against a solid metal or plastic part in response to rotational movements of the load leg during a collision. A further design may relate to bending or deforming a lattice shaped plastic part in response to rotational movements of the load leg during a collision. In accordance with another torsional design, the rotation of the load leg may cause a spring or gas strut to compress thereby absorbing collision energy. In yet another embodiment, the rotation of the load leg may cause a metal rod or tube to deform a set of interlocking gear shaped parts. For example, the rod or tube would bend each gear tooth as it rotates past each point.

In accordance with additional aspects, the load leg energy absorption system of the present disclosure may use a translational design where a linear action of the load leg deforms an internal or external member, or where the linear action of the load leg compresses a spring, or where the linear action of the load leg shears the locking mechanism of the load leg through the series of locking positions.

In one embodiment, the load leg energy absorption system of the present disclosure may not be folded under the car seat frame for storage, but is rather removed from the child safety seat base entirely in the event of a non-use situation.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a first embodiment of a load leg energy absorption system, according to an exemplary aspect of the present disclosure;

FIG. 2 illustrates an assembled view of an energy absorption component, according to an exemplary aspect of the present disclosure;

FIG. 3 illustrates an exploded view of the energy absorption component of FIG. 2, according to an exemplary aspect of the present disclosure;

FIG. 4 illustrates a second embodiment of a load leg energy absorption system, according to an exemplary aspect of the present disclosure;

FIG. 5 illustrates an assembled view of an energy absorption component, according to an exemplary aspect of the present disclosure;

FIG. 6 illustrates an exploded view of the energy absorption component of FIG. 5, according to an exemplary aspect of the present disclosure;

FIG. 7 illustrates a side view of the energy absorption component of FIG. 5, according to an exemplary aspect of the present disclosure;

FIG. 8 illustrates a first embodiment of a curved slit, according to an exemplary aspect of the present disclosure;

FIG. 9 illustrates a second embodiment of a curved slit, according to an exemplary aspect of the present disclosure;

FIG. 10 illustrates a third embodiment of a load leg energy absorption system, according to an exemplary aspect of the present disclosure;

FIG. 11 illustrates a fourth embodiment of a load leg energy absorption system, according to an exemplary aspect of the present disclosure;

FIG. 12 illustrates a fifth embodiment of a load leg energy absorption system, according to an exemplary aspect of the present disclosure;

FIG. 13 illustrates a sixth embodiment of a load leg energy absorption system, according to an exemplary aspect of the present disclosure;

FIG. 14 illustrates a seventh embodiment of a load leg energy absorption system, according to an exemplary aspect of the present disclosure; and

FIG. 15 illustrates an eighth embodiment of a load leg energy absorption system, according to an exemplary aspect of the present disclosure.

### DETAILED DESCRIPTION

Various aspects of the present disclosure will be described with reference to the drawings, wherein like reference numerals are used to refer to like elements throughout. In the following description, for purposes of explanation, numerous specific details are set forth in order to promote a thorough understanding of one or more aspects of the present disclosure. It may be evident in some or all instances, however, that any aspects described below can be practiced without adopting the specific design details described below.

To improve safety of a child occupant in a vehicle collision, certain child safety seats may include load legs. A load leg, which is also called a foot prop or support leg, may be in the form of a metal pole that extends downwards from a base of, e.g., a rear-facing car seat or a convertible car seat, and rests on the floor of a vehicle. Crash tests show that load legs may add stabilization and better integrate the child safety seat to the vehicle during a crash, thereby significantly reducing the transfer of crash energy to the child occupant's head and neck and keeping the child occupant's brain and spine safer.

The present disclosure generally relates to a load leg energy absorption system of a child safety seat configured to decrease crash forces on a child occupant's body while redistributing remaining forces onto the strongest part of the child's body such as the back. For example, in a frontal crash, a rear-facing child occupant and the safety seat may move towards to the front of the vehicle while rotating down toward the floor as the vehicle's seat cushion compresses. During this downward rotation, the child occupant may slide up abruptly in the safety seat, and crash forces may become significant in the neck and shoulders as they make contact with the corresponding harnesses or seat belts associated with the safety seat. Generally, the more movement a child occupant has during a collision, the more chance for injury. The present disclosure advantageously provides a load leg energy absorption system configured to reduce or even eliminate the downward rotation during a collision. In one aspect, the disclosed system allows a child safety seat to maintain a more upright position during the collision. As a result, the back of the safety seat absorbs energy instead of the associated harnesses and seat belts, and the crash forces are distributed along the child occupant's back rather than concentrated on the neck and shoulders. Further, the disclosed system reduces the chance that the child occupant may slide up and out of the safety seat and strike the vehicle interior on the head as the seat maintains a more upright position during the collision.

In addition, following the downward rotation during the collision, the safety seat may pivot around its belt path and move back up toward the vehicle seat. The load leg energy absorption system of the present disclosure allows the energy of the initial crash to be absorbed by at least various components of the disclosed system while limiting or eliminating the downward motion, thereby reducing the rebound of the safety seat into the vehicle interior. As will be described fully below, the disclosed system may be configured to redirect at least a portion of an impact force imposed along one trajectory to a reaction force distributed along another trajectory.

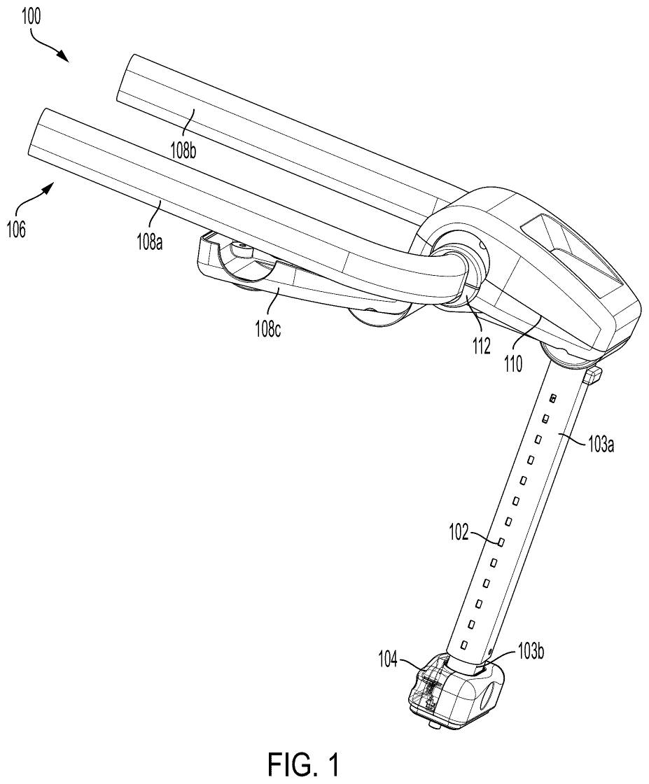

In accordance with aspects of the present disclosure, FIG. 1 illustrates a perspective view of a first embodiment of a load leg energy absorption system 100 to be used with a child safety seat in a vehicle. The system 100 may include a load leg 102 that can be positioned to abut against a floor of the vehicle via a component 104, a safety seat support component 106, and an energy absorption assembly or component 110 configured to connect the load leg 102 and the safety seat support component 106. The load leg 102 may include a first tubular member 103a that is telescopically moveable relative to a second tubular member 103b, such that a user may adjust the length load leg 102 while fixing it to the floor of the vehicle. For example, a plurality of holes may be implemented on the first tubular member 103a to secure and lock the telescopic tubular members 103a and 103b into one of a number of discrete positions. It should be appreciated that any suitable adjustment mechanisms may be implemented to extend or retract the load leg 102 to a desired length. For example, the load leg 102 may include a plurality of nested concentric tubular portions configured to slide relative to one another to achieve a continuously adjustable length. Each nested concentric tubular portion may be partially or fully exposed or covered by telescopically extending or retracting an adjacent nested concentric tubular portion. The nested concentric tubular portions may interlock with one another to maintain a desired position via, e.g., a snap-fit mechanism. In another example, telescoping sliding tubular portions 103a and 103b of the load leg 102 may be held in frictional contact through one or more ribs or O-rings on the sliding surface of one or both sliding portions 103a and 103b.

The safety seat support component 106 of the system 100 may include two parallel side portions 108a, 108b and a safety seat base support member 108c. When a child safety seat is installed on a vehicle seat, either in a rear-facing or forward-facing direction, the safety seat support component 106 may be configured to engage with corresponding coupling components of the child safety seat to secure it to the vehicle seat and restrict displacement movements therebetween when a collision occurs. A collision generally refers to a short-duration interaction between two or more bodies, resulting in a change in motion of the bodies involved due to internal forces acting between them. Collisions may be elastic, inelastic or some combination of both. Any collisions conserve momentum. Elastic collisions conserve both momentum and kinetic energy; whereas, inelastic collisions conserve momentum, but not kinetic energy. Generally, a car collision is an inelastic collision because some of the kinetic energy due to the collision is transformed into other forms of energy such as heat and sound.

The safety seat support component 106 may be connected with the energy absorption assembly 110 via a clamp joint 112. Specifically, the clamp joint 112 includes a top halve and a bottom halve completing a full circumference on the outer surface of the two parallel side portions 108a, 108b of the safety seat support component 106. The clamp joint 112 may be configured to reduce the vibration and displacement movements between the child safety seat and the load leg energy absorption system 100.

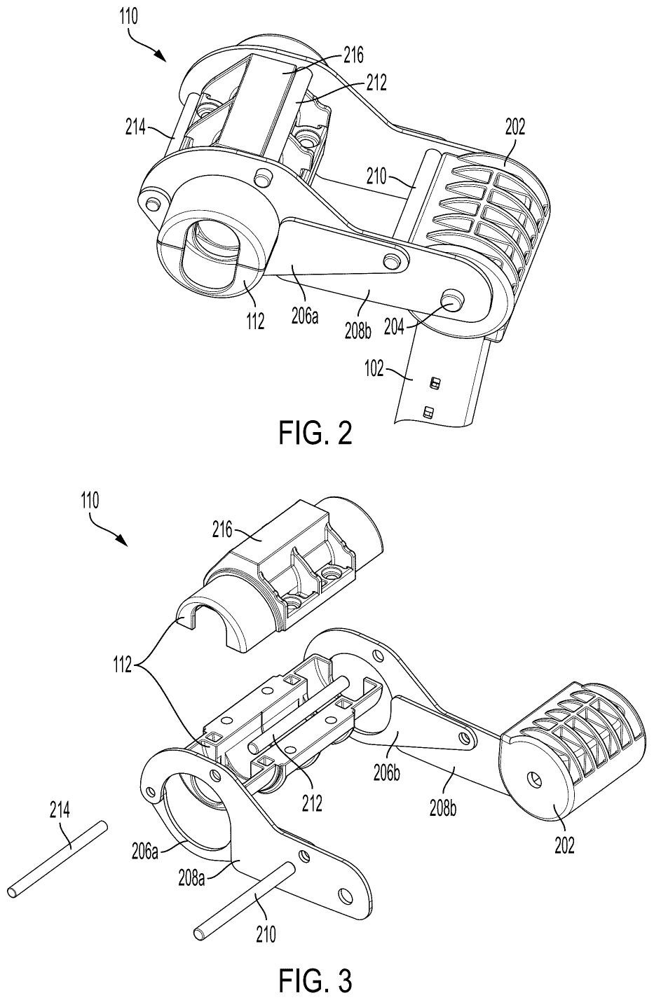

FIGS. 2 and 3 show an assembled view and an exploded view of various components of the energy absorption assembly 110, respectively. The energy absorption assembly 110 may include a shield component 202 rotatably supported by and connected with the load leg 102 via a rotate axle or shaft 204. The shield component 202 may be pivotally secured to the clamp joint 112 via two pairs of plates 206a, 208a, 206b, and 208b respectively disposed on two sides to support the rotate axle or shaft 204, a first torsion shaft or pin 210, a second torsion shaft or pin 212, and a dowel pin 214. In one aspect, the clamp joint 112 may include a biasing structure 216 to limit the rotation between the load leg energy absorption system 100 and the coupled child safety seat during a collision by deforming and shearing the torsion shaft or pin 212. Similarly, the shield component 202 may be shaped and dimensioned to bias against the torsion shaft or pin 210 to slow down any downward motion during a collision and allow the energy absorption assembly 110 to absorb energy associated with yielding of the torsion shaft or pin 210. Further, the dowel pin 214, which may be a solid, headless, cylindrical metal rob that have been machined to specific tolerances, may be used to align, locate, and pivotally join the shield component 202 and the clamp joint 112 on a distal end to further absorb lateral stress during a collision.

In one embodiment, the amount of energy absorbed by the energy absorption assembly 110 due to the deformation of the torsion pins 210 and 212 may depend on the amount of torque (toque to yield) required to achieve a deformation, yielding, or a permanent change in the shape of each torsion pin. The torque to yield (T) of the torsion pin depends on the diameter (D) of the torsion pin, and the torsional yield strength of the material that comprises such torsion pin. The value of the torque to yield (T) may be calculated from the torsional yield strength (τ) and the diameter as follows: T=(τ*πD³)/16, wherein τ is the maximum shear stress at the outer surface of each torsion pin 210 and 212. If each torsion pin 210 and 212 is loaded only in torsion, then one of the principal stresses will be in tension and the other in compression. If each torsion pin 210 and 212 is made of brittle material, then each pin will fail during, e.g., a collision, by a crack initiating at the surface and propagating through to the core of each pin, thereby dissipating crash energy to the energy absorption assembly 110 to direct the energy away from the child occupant.

It should be appreciated that the specific implementation, dimensions, shapes, and displacements of various components of the energy absorption assembly 110 may be determined and modified to achieve the desired energy absorption characteristics of the load leg energy absorption system 100. For example, the energy absorption characteristics of the load leg energy absorption system 100 may be adjusted by modifying how much one or both of the shield component 202 and the clamp joint 112 may rotate before engaging the torsion pins 210 and 212, respectively, modifying the materials that comprise the torsion pins 210 and 212, and/or modifying the diameters of the torsion pins 210 and 212. The load leg energy absorption system 100 may be further customized by equipping or fitting the outer surface of the system 100 with an energy absorbent or cushioned material such as a metal honeycomb, or a crushable material such as a foam.

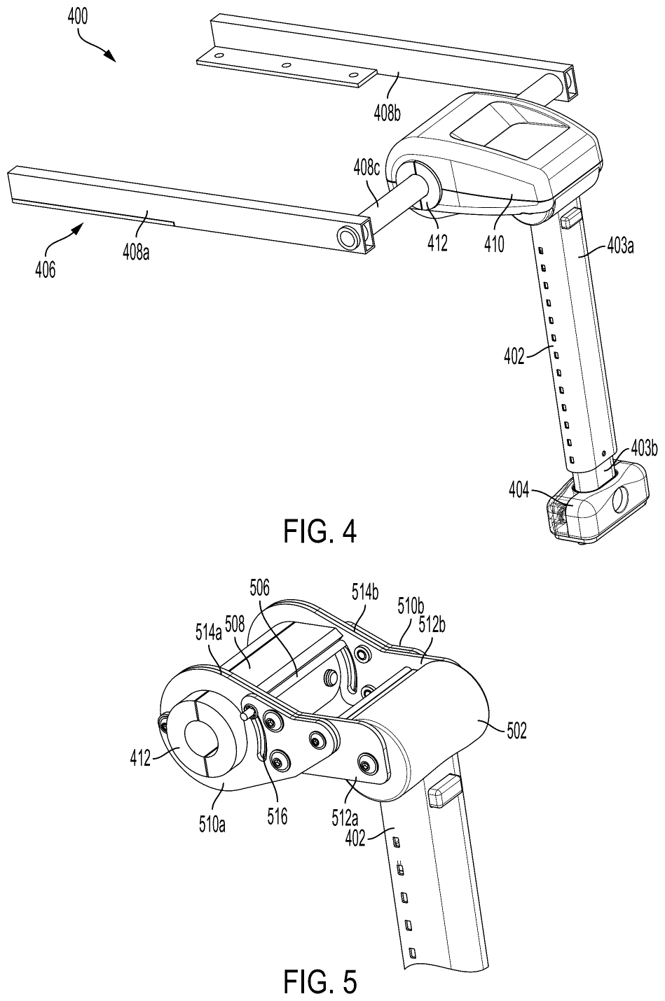

In accordance with aspects of the present disclosure, FIG. 4 illustrates a perspective view of a second embodiment of a load leg energy absorption system 400 to be used with a child safety seat in a vehicle. The system 400 may include a load leg 402 that can be positioned to abut against a floor of the vehicle via a component 404, a safety seat support component 406, and an energy absorption assembly 410 configured to connect the load leg 402 and the safety seat support component 406.

In some embodiments, the load leg 402 may include a first tubular member 403a that is telescopically moveable relative to a second tubular member 403b, such that a user may adjust the length load leg 402 while fixing it to the floor of the vehicle. For example, a plurality of holes may be implemented on the first tubular member 403a to secure and lock the telescopic tubular members 403a and 403b into one of a number of discrete positions. It should be appreciated that any suitable adjustment mechanisms may be implemented to extend or retract the load leg 402 to a desired length. For example, the load leg 402 may include a plurality of nested concentric tubular portions configured to slide relative to one another to achieve a continuously adjustable length. Each nested concentric tubular portion may be partially or fully exposed or covered by telescopically extending or retracting an adjacent nested concentric tubular portion. The nested concentric tubular portions may interlock with one another to maintain a desired position via, e.g., a snap-fit mechanism. In another example, telescoping sliding tubular portions 403a and 403b of the load leg 402 may be held in frictional contact through one or more ribs or O-rings on the sliding surface of one or both sliding portions 403a and 403b.

The safety seat support component 406 of the system 400 may include two parallel side portions 408a, 408b and a horizontal support member 408c pivotally coupled with the energy absorption assembly 410. When a child safety seat is installed on a vehicle seat, either in a rear-facing or forward-facing direction, the safety seat support component 406 may be configured to engage with corresponding coupling components of the child safety seat to secure it to the vehicle seat and restrict displacement movements therebetween when a collision occurs. The horizontal support member 408c of the safety seat support component 406 may be connected with the energy absorption assembly 410 via a coupling member 412. Specifically, the coupling member 412 includes a left halve and a right halve completing a full circumference on the outer surface of the horizontal support member 408c of the safety seat support component 406. The coupling member 412 may be configured to reduce the vibration and displacement movements between the child safety seat and the load leg energy absorption system 400.

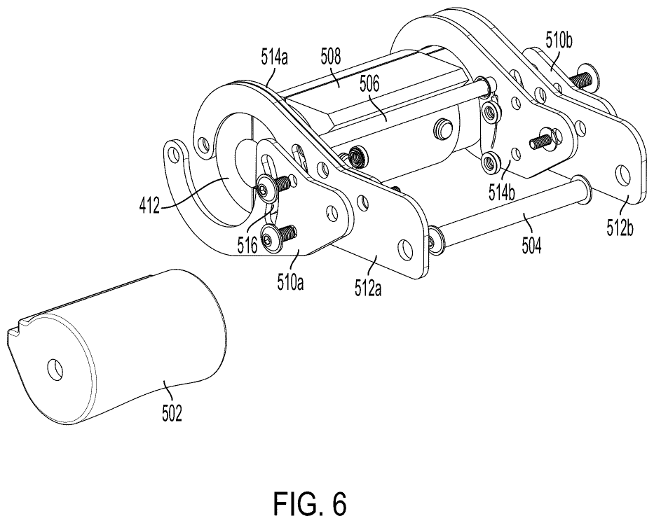

FIGS. 5 and 6 show an assembled view and an exploded view of various components of the energy absorption assembly 410, respectively. The energy absorption component 410 may include a component 502 rotatably supported by and connected with the load leg 402 via a rotate shaft 504, as shown in FIG. 6. The component 502 may be pivotally secured to the coupling member 412 via a number plates respectively disposed on two sides to support the rotate shaft 504 and a torsion shaft or pin 506. In one aspect, the right halve of the coupling member 412 may include a structure 508 to maintain the torsion pin 506 in an initial un-deformed configuration and limit the rotation between the load leg energy absorption system 400 and the coupled child safety seat during a collision by deforming and shearing the torsion shaft or pin 506. That is, the structure 508 may be shaped and dimensioned to bias against the torsion shaft or pin 506 to slow down any downward motion of the attached child safety seat during a collision and allow the energy absorption assembly 410 to absorb energy associated with yielding of the torsion shaft or pin 506.

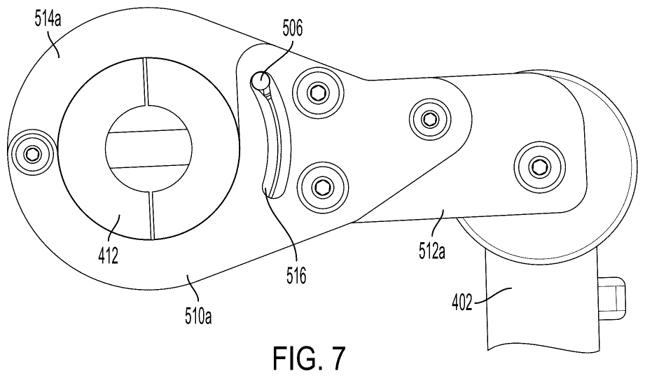

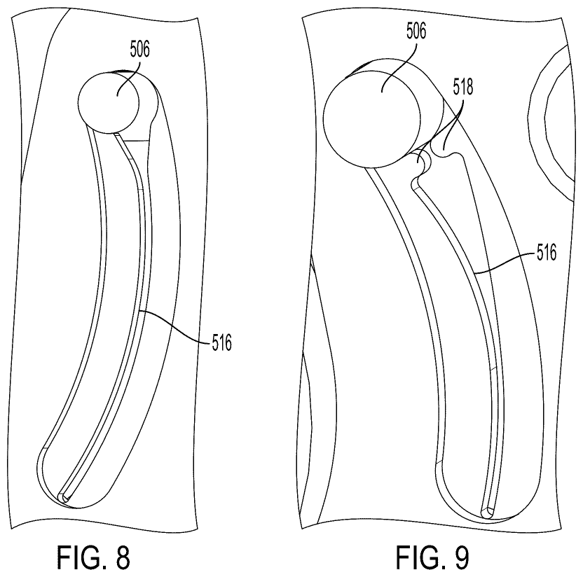

The component 502 may be pivotally secured to the coupling member 412 via first rotate plates 510a, 510b, second rotate plates 512a, 512b, and sacrificial plates 514a, 514b disposed on two sides, respectively. For example, rotate plates 510a, 512a and sacrificial plate 514a may be bolted or secured together via any suitable means on one side to define a curved slit 516 to slidably receive one distal end of the torsion shaft or pin 506, as shown in FIGS. 7, 8, and 9. The curved slit 516 maintains the torsion shaft or pin 506 at one distal end in the initial un-deformed configuration where the diameter of the curved slit 516 is equal to the diameter of the torsion pin 506. The curved slit 516 extends downward and gradually decreases to be narrower than the diameter of the torsion pin 506. Upon a vehicle collision, the load leg 402 rotates at least the sacrificial plates 514a, 514b to bias the torsion shaft or pin 506 into engagement with the narrower portions of the curved slit 516 in response to the crash force imparted on the load leg energy absorption system 400.

In one embodiment, as shown in FIG. 8, the curved slit 516 may generally allow the torsion shaft or pin 506 to move within a top portion of the slit 516 in response to minor rotational movements between the load leg energy absorption system 400 and the coupled child safety seat. If a sufficient crash force is exerted on the load leg energy absorption system 400, the load leg 402 rotates at least the sacrificial plates 514a, 514b to push the torsion shaft or pin 506 downward toward narrower portions of the curved slit 516, thereby transmitting energy associated with the collision to the load leg energy absorption system 400. That is, the downward motion of the coupled child safety seat due to the collision may be slowed down or completely halted. If additional force is applied, the load leg 402 and the sacrificial plates 514a, 514b continue to rotate about the torsion pin 506 until a near maximum deformation of the load leg energy absorption system 400 is achieved. In some embodiments, such maximum deformation of the torsion pin 506 may be achieved when various components of the load leg energy absorption system 400 strike one another sufficiently to maintain the torsion pin 506 at a specific location within the curved slit 516 and stop any rotational movements due to the collision. In other embodiments, the sacrificial plates 514a, 514b and the torsion pin 506 may be made of a material that deforms, partially or completely ruptures or breaks to absorb additional force applied to the load leg energy absorption system 400, thereby minimizing the collision force transferred to the safety seat support component 406 and the child occupant.

In another embodiment, as shown in FIG. 9, the curved slit 516 may include nubbins or any suitable structure 518 to maintain the torsion shaft or pin 506 at the top distal end in the initial un-deformed configuration where the diameter of the curved slit 516 is equal to the diameter of the torsion pin 506. In response to detecting a sufficient crash force exerted on the load leg energy absorption system 400, the load leg 402 rotates at least the sacrificial plates 514a, 514b to push the torsion shaft or pin 506 downward to break the nubbins 518 and move toward narrower portions of the curved slit 516, thereby transmitting energy associated with the collision to the load leg energy absorption system 400. That is, the downward motion of the coupled child safety seat due to the collision may be slowed down or completely halted. If still additional force is applied, the load leg 402 and the sacrificial plates 514a, 514b continue to rotate about the torsion pin 506 until a near maximum deformation of the load leg energy absorption system 400 is achieved. In some embodiments, such maximum deformation of the torsion pin 506 may be achieved when various components of the load leg energy absorption system 400 strike one another sufficiently to maintain the torsion pin 506 at a specific location within the curved slit 516 and stop any rotational movements due to the collision. In other embodiments, the sacrificial plates 514a, 514b and the torsion pin 506 may be made of a material that deforms, partially or completely ruptures or breaks to absorb additional force applied to the load leg energy absorption system 400, thereby minimizing the collision force transferred to the safety seat support component 406 and the child occupant.

It should be appreciated that the specific implementation, dimensions, shapes, and displacements of various components of the energy absorption assembly 410 may be determined and modified to achieve the desired energy absorption characteristics of the load leg energy absorption system 400. For example, the energy absorption characteristics of the load leg energy absorption system 400 may be adjusted by modifying how much one or both of the load leg 402 and the sacrificial plates 514a, 514b may rotate before engaging the torsion pin 506; modifying the materials that comprise the sacrificial plates 514a, 514b, the torsion pin 506, and the nubbins 518; modifying the dimension, shape, structure, and/or configuration of the curve slit 516 to restrict the movements of the torsion pin 506 in response to detected collision force; and/or modifying the diameters of the torsion pin 506. The load leg energy absorption system 400 may be further customized by equipping or fitting the outer surface of the system 400 with an energy absorbent or cushioned material such as a metal honeycomb, or a crushable material such as a foam.

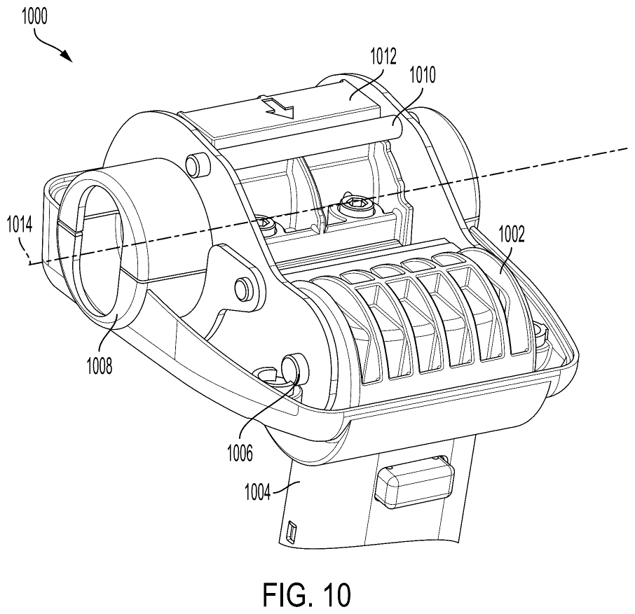

According to a third embodiment of the present disclosure, FIG. 10 illustrates a perspective view of a load leg energy absorption system 1000 to be used with a child safety seat in a vehicle. Similar to the energy absorption component 110 of FIGS. 1-3, the load leg energy absorption system 1000 may include a shield component 1002 rotatably supported by and connected with the load leg 1004 via a rotate axle or shaft 1006. The shield component 1002 may be pivotally secured to a clamp joint 1008 via a number of plates respectively disposed on two sides to support the rotate axle or shaft 1006 and a torsion rod or tube 1010. In one aspect, the clamp joint 1008 may include a biasing structure 1012 to limit the rotation movements with respect the axis 1014 between the load leg energy absorption system 1000 and the coupled child safety seat during a collision by deforming and bending the torsion rod or tube 1010. In one aspect, the biasing structure 1012 may be made of solid metal or plastic and configured to bias against the torsion rod or tube 1010 to slow down any downward motion during a collision and allow the energy absorption component 1000 to absorb energy associated with yielding of the torsion rod or tube 1010.

In one embodiment, the amount of energy absorbed by the energy absorption component 1000 due to the deformation of the torsion rod or tube 1010 may depend on the amount of torque (toque to yield) required to achieve a deformation, yielding, or a permanent change in the shape of the torsion rod or tube 1010. The torque to yield (T) of the torsion rod or tube 1010 depends on its diameter (D), and the torsional yield strength of the material that comprises such torsion rod or tube. The value of the torque to yield (T) may be calculated from the torsional yield strength (τ) and the diameter as follows: T=(τ*πD³)/16, wherein t is the maximum shear stress at the outer surface of the torsion rod or tube 1010. If the torsion rod or tube 1010 is loaded only in torsion, one of the principal stresses will be in tension and the other in compression. If made of brittle material, the torsion rod or tube 1010 will fail during, e.g., a collision, by a crack initiating at the surface and propagating through to the core of the torsion rod or tube 1010, thereby dissipating crash energy to the energy absorption component 1000 to direct the energy away from the child occupant.

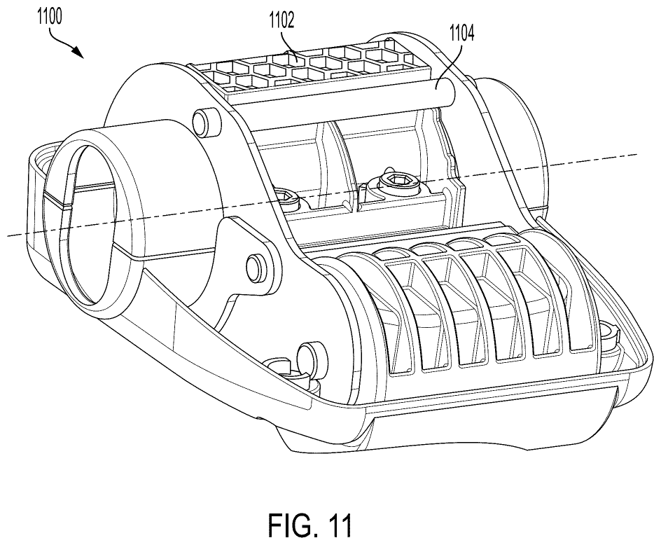

According to a forth embodiment of the present disclosure, FIG. 11 illustrates a perspective view of a load leg energy absorption system 1100 to be used with a child safety seat in a vehicle. The load leg energy absorption system 1100 is generally similar to the load leg energy absorption system 1000 of FIG. 10. Rather than bending the torsion rod or tube 1010 as shown in FIG. 10, the load leg energy absorption system 1100 may include a lattice shaped plastic part 1102 which may be bent or deformed during the rotation of a load leg. That is, the torsion rod or tube 1102 may be configured to cause the lattice shaped plastic part 1102 to bend and deform during a collision, thereby slowing down any downward motion and allowing the energy absorption component 1100 to absorb energy associated with yielding of the lattice shaped plastic part 1102. Example lattice structures may include but not limited to re-entrant auxetic, hexagonal, and AuxHex.

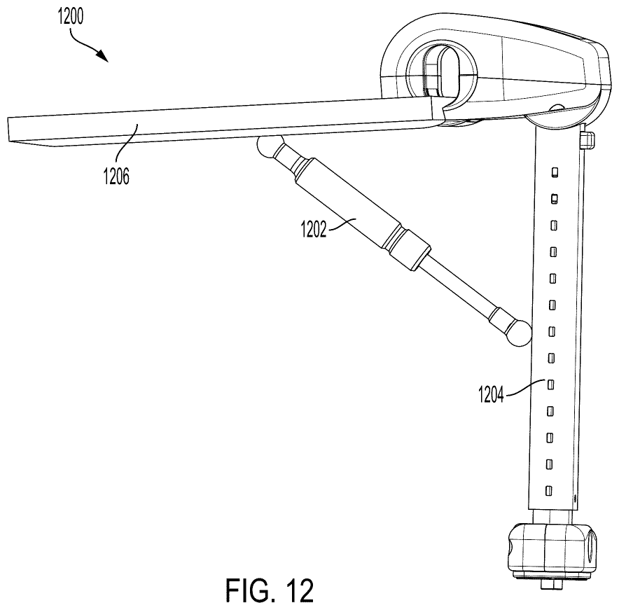

FIG. 12 illustrates a fifth embodiment of the present disclosure. A load leg energy absorption system 1200 may be used with a child safety seat in a vehicle where the rotation of a load leg causes a spring or gas strut 1202 to compress, thereby absorbing energy resulting from a vehicle collision. In normal use, prior to a vehicle collision, the spring or gas strut 1202, which is positioned to abut against the load leg 1204 and a child seat support structure 1206 at two respective distal ends, has not been compressed and is therefore in an initial configuration. In the event of a vehicle collision, the downward rotation of the child occupant, the child safety seat, and the child seat support structure 1206 cause the spring or gas strut 1202 to compress. As a result, the compression transfers some energy from the moving seat and occupant into the spring or gas strut 1202. Once the downward rotation has reached its peak, the compressed spring or gas strut 1202 may start releasing the energy previously stored therein by expanding back toward its original length. As the spring or gas strut 1202 expands, the child seat support structure 1206 may be restored to its original position.

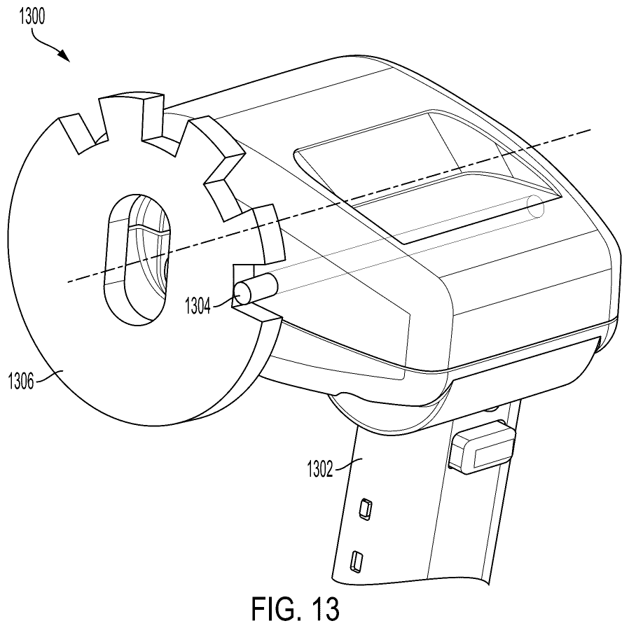

According to a sixth embodiment of the present disclosure, FIG. 13 illustrates a perspective view of a load leg energy absorption system 1300 to be used with a child safety seat in a vehicle. Specifically, FIG. 13 shows a torsional design where the rotation of a load leg 1302 during a collision causes a rod or tube 1304 of the load leg energy absorption system 1300 to deform a set of interlocking gear shaped parts 1306. The rod or tube 1304 may be made of metal and may bend against each gear “tooth” of the set of interlocking gear shaped parts 1306 as it rotates past each point. For example, the rod or tube 1304 may initially terminate in one of a plurality of gear teeth of the set of interlocking gear shaped parts 1306 in normal use. In one embodiment, the plurality of gear teeth may be implemented on a selected portion of the outer circumference of the parts 1306. During a vehicle collision, the downward rotation of the child occupant and the safety seat may cause the rod or tube 1304 to move counterclockwise from the initial position to engage with an adjacent gear tooth in a radial direction. That is, the set of interlocking gear shaped parts 1306 may provide multiple lockable differential torque limiting functions in response to crash impact. The plurality of gear teeth may sequentially shear or fail in response to increasing crash impact as the rod or tube 1304 continues rotating due to the collision, thereby preventing a shattering of the load leg 1302 before the torque limits of the parts 1306 are reached.

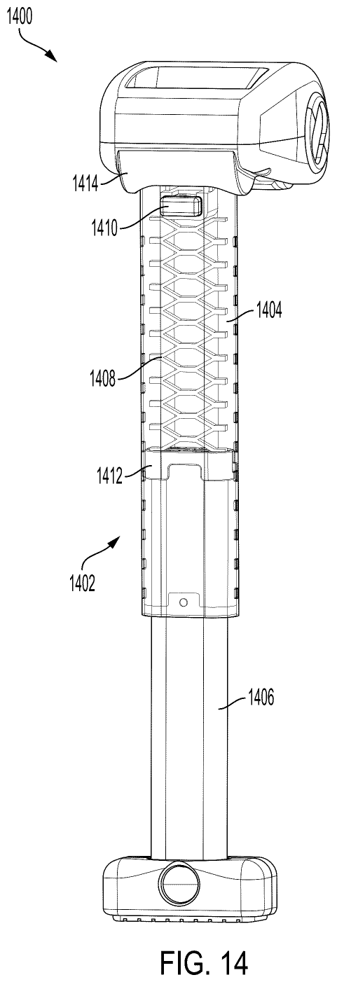

According to a seventh embodiment of the present disclosure, FIG. 14 illustrates a perspective view of a load leg energy absorption system 1400 to be used with a child safety seat in a vehicle. Specifically, FIG. 14 shows a translational design where the linear action of a load leg 1402 deforms an internal or external member. Similar to the load leg 102 depicted in FIG. 1, the load leg 1402 may include a first tubular member 1404 that is telescopically moveable relative to a second tubular member 1406, such that a user may adjust the length load leg 1402 while fixing it to the floor of the vehicle. For example, a plurality of holes may be implemented on the first tubular member 1404 to secure and lock the telescopic tubular members 1404 and 1406 into one of a number of discrete positions. Other suitable adjustment mechanisms may be implemented to extend or retract the load leg 1402 to a desired length. In one embodiment, the load leg 1402 may include a plurality of nested concentric tubular portions configured to slide relative to one another to achieve a continuously adjustable length. Each nested concentric tubular portion may be partially or fully exposed or covered by telescopically extending or retracting an adjacent nested concentric tubular portion. The nested concentric tubular portions may interlock with one another to maintain a desired position via, e.g., a snap-fit mechanism. In another example, telescoping sliding tubular portions 1404 and 1406 of the load leg 1402 may be held in frictional contact through one or more ribs or O-rings on the sliding surface of one or both sliding portions 1404 and 1406.

In some implementations, a deformable internal member 1408 may be disposed coaxially within the first tubular member 1404 of the load leg 1402 between a linear motion actuator 1410 and a distal component 1412, as shown in FIG. 14. During collision, crash impact may cause the load leg 1402 to move in the lengthwise direction. As a result, the deformable internal member 1408 generates a translational force in accordance with its elastic deformation amount. That is, the expansion and compression of the deformable internal member 1408 due to the linear motion of the load leg 1402 may generate a translational force to maintain the child safety seat connected to the load leg 1402 in a more upright position.

In an alternate embodiment (not shown), a deformable member may be disposed external to the load leg 1402 and configured to generate a translational force in response to detected linear motion of the load leg 1402. For example, an upper distal end of the deformable member may be attached to the bottom of a shield component 1414 which is rotatably supported by and connected with the load leg 1402 via a rotate axle or shaft.

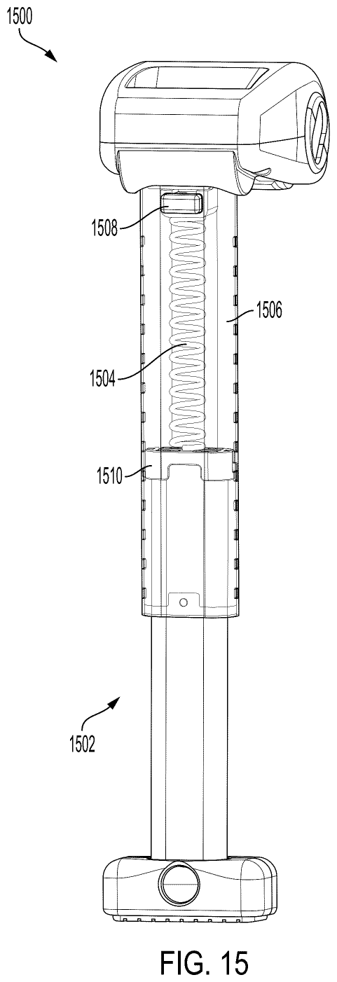

According to an eighth embodiment of the present disclosure, FIG. 15 illustrates a perspective view of a load leg energy absorption system 1500 to be used with a child safety seat in a vehicle. Specifically, FIG. 15 shows a translational design where the linear action of a load leg 1502 compresses a spring 1504. Similar to the deformable internal member 1408 of FIG. 14, the spring 1504 expands or compresses in response to detected linear motion of the load leg 1502 and generates a translational force in accordance with its elastic deformation amount to maintain the child safety seat connected to the load leg 1502 in a more upright position. In some implementations, the spring 1504 may be disposed coaxially within a tubular member 1506 of the load leg 1502 between a linear motion actuator 1508 and a distal component 1510.

In yet another embodiment (not shown), the present disclosure may include a translational design where the linear action of a load leg shears the locking mechanism of the load leg through a series of locking positions.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Throughout this disclosure, terms like “advantageous”, “exemplary” or “preferred” indicate elements or dimensions which are particularly suitable (but not essential) to the disclosure or an embodiment thereof, and may be modified wherever deemed suitable by the skilled annotator, except where expressly required. Accordingly, the scope of the invention should be determined not by the embodiments illustrated, but by the appended claims and their equivalents.

The terms “a,” “an,” “the” and similar referents used in the context of describing the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this present disclosure are described herein, including the best mode known to the inventors for carrying out the present disclosure. Of course, variations on these described embodiments will become apparent to those of ordinary skill in the art upon reading the foregoing description. The skilled artisans are expected to employ such variations as appropriate. Accordingly, this present disclosure includes all modifications and equivalents of the subject matter recited in the claims appended hereto as permitted by applicable law. Moreover, any combination of the above-described elements in all possible variations thereof is encompassed by the present disclosure, unless otherwise indicated herein or otherwise clearly contradicted by context.

1. A system, comprising:
a load leg positioned to abut against a floor of a vehicle;
a support component configured to engage with corresponding coupling components of a child safety seat to secure the child safety seat to a selected vehicle seat and restrict displacement movements therebetween when a collision occurs; and
an energy absorption assembly configured to connect the load leg and the support component and absorb crash energy during the collision by at least limiting or eliminating downward motions of a child occupant in the child safety seat.

2. The system of claim 1, wherein the load leg includes a first tubular member and a second tubular member, wherein the first tubular member is telescopically moveable relative to the second tubular member for adjusting a length of the load leg.

3. The system of claim 1, wherein the energy absorption assembly is rotatably connected with the support component via a joint and rotatably connected with the load leg via a connection component a first torsion shaft, wherein the connection component is pivotally secured to the joint via a plurality of plates respectively disposed at two sides to support at least the first torsion shaft and a second torsion shaft biased against a structure of the joint.

4. The system of claim 3, wherein the structure of the joint is configured to limit rotation movements of the second torsion shaft during the collision by deforming and shearing the second torsion shaft in response to an amount of torque generated by the second torsion shaft.

5. The system of claim 3, wherein the connection component is configured to bias against the first torsion shaft to allow the energy absorption assembly to absorb energy generated by the deforming and shearing of the second torsion shaft.

6. The system of claim 3, wherein the energy absorption assembly further comprises a dowel pin configured to pivotally join the connection component and the joint 112 on a distal end to further absorb lateral stress during the collision.

7. The system of claim 4, wherein the amount of torque generated by the second torsion shaft is a function of a diameter of the second torsion shaft and a torsional yield strength of a material that comprises the second torsion shaft.

8. The system of claim 3, wherein the plurality of plates include a pair of sacrificial plates respectively disposed at the two sides, each sacrificial plate including a curved slit for slidably receiving one distal end of the second torsion shaft.

9. The system of claim 8, wherein the curved slit maintains the second torsion shaft at the one distal end in an initial un-deformed configuration, wherein a diameter of the curved slit is equal to a diameter of the second torsion shaft.

10. The system of claim 9, wherein the curved slit extends downward and gradually decreases to be narrower than the diameter of the second torsion shaft.

11. The system of claim 10, wherein the load leg rotates at least the pair of sacrificial plates to bias the second torsion shaft into engagement with a narrower portion of the curved slit during the collision.

12. The system of claim 11, wherein the pair of sacrificial plates and the second torsion shaft are made of a material that deforms and ruptures to absorb crash force applied to the energy absorption assembly during the collision.

13. The system of claim 8, wherein the curved slit includes nubbins configured to maintain the second torsion shaft at a top distal end in an initial un-deformed configuration where a diameter of the curved slit is equal to a diameter of the second torsion shaft.

14. The system of claim 13, wherein the load leg rotates at least the pair of sacrificial plates to move the second torsion shaft to break the nubbins and engage with a narrower portion of the curved slit during the collision.

15. The system of claim 3, wherein the structure of the joint is made of metal or plastic configured to bend the second torsion shaft as the load leg rotates during the collision.

16. The system of claim 3, wherein the structure of the joint is a lattice shaped plastic part configured to bend and deform the second torsion shaft as the load leg rotates during the collision.

17. The system of claim 16, wherein a lattice structure of the lattice shaped plastic part includes at least one of a re-entrant auxetic, hexagonal, and AuxHex.

18. The system of claim 1, further comprising a spring or gas strut positioned to abut against the load leg and the support component at two respective distal ends.

19. The system of claim 18, wherein the spring or gas strut compresses during the collision to transfer a portion of crash energy from the child occupant and the child safety seat into the spring or gas strut.

20. The system of claim 3, further comprising a part disposed adjacent the joint and rotatably connected with the second torsion shaft, wherein the part includes a plurality of gear teeth configured to maintain the second torsion shaft in one of the plurality of gear teeth.

21. The system of claim 20, wherein the plurality of gear teeth are implemented on a selected portion of an outer circumference of the part.

22. The system of claim 20, wherein the load leg rotates during the collision to cause the second torsion shaft move in a radial direction and lock into another gear tooth of the part in response to crash impact of the collision.

23. The system of claim 22, wherein at least a portion of the plurality of gear teeth fail in response to increasing crash impact as the second torsion shaft continues rotating due to the collision.

24. The system of claim 2, further comprising a deformable member implemented internally or externally to the load leg.

25. The system of claim 24, wherein the deformable member is implemented within the load leg coaxially and connected to a linear motion actuator at one distal end to detect linear motions of the load leg due to the collision.

26. The system of claim 25, wherein the deformable member is configured to expand or compress to generate a translational force in response to detected linear motions of the load leg to maintain the child safety seat connected to the load leg in an upright position.

27. The system of claim 24, wherein the deformable member includes a spring.

28. The system of claim 1, wherein the load leg includes a series of locking positions.

29. The system of claim 28, wherein at least a portion of the series of locking positions shear in response to increasing linear motions of the load leg due to the collision.

30. The system of claim 1, wherein the system is removable from the vehicle.
